(19) United States
(12) Patent Application Publication
(10) Pub. No.: US 2008/0115009 A1
(43) Pub. Date: May 15, 2008

(54) Registers in a communication system

(75) Inventors: Kari Silfverberg, Mouhijarvi (FI); Mikko Ruhanen, Tampere (FI); Petri Aalto, Pirkkala (FI); Paavo Helenius, Toijala (FI); Auvo Hartikainen, Tampere (FI); Vesa Blom, Pirkkala (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/582,619

(22) Filed: Oct. 17, 2006

(51) Int. Cl. G06F 11/00

(52) U.S. Cl. 714/8

(57) ABSTRACT

An apparatus comprising a data storage configured to store and update a copy of data that is stored in a plurality of registers of a network wherein the registers are provided for storing data associated with respective users of the network. The apparatus is configured to communicate data from the data storage to at least one of the registers subsequent to detection of a failure in association with at least one of the registers.

### FIELD OF THE INVENTION

The present invention relates to a communication system, and in particular to registers associated with users of the communications system.

### BACKGROUND INFORMATION

A communication system is a facility which facilitates the communication between two or more entities such as communication devices, network entities and other nodes. A communication system may be provided by one or more interconnect networks. One or more gateway nodes may be provided for interconnecting various networks of the system and/or for connection a communication system to at least one another communication systems.

A communication device can be understood as a device provided with appropriate communication and control capabilities for enabling the user thereof to communicate with others parties. The communication may comprise, for example, communication of voice, electronic mail (email), text messages, data, multimedia and so on.

An appropriate access system allows the communication device to access to the wider communication system. An access to the communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

In the cellular systems a network entity in the form of a base station provides a node for communication with mobile devices in one or more cells or sectors. It is noted that in certain systems a base station is called ‘Node B’. When a mobile device moves from a base station to another base station, handover techniques are used to ensure that the user may continue any active communications connections as a consequence of the move. The mobile systems are also typically provided with appropriate mobility management functions to ensure that a user can be served in a similar manner regardless his/hers location. These functions include registers for maintaining data that is associated with each user, so called user or subscriber data. The registers typically are for storing and managing data such as subscriber profile, current location and so forth.

In certain cellular systems two different types of registers are provided. Each user or subscriber is assigned with i.e. belongs to a main register facility, for example a home location register (HLR) or a home subscriber server (HSS). This entity centrally stores up-to-date information associated with users that are allocated thereto. It is noted that a cellular network is typically provided with a number of home location registers. Another layer or registers is then provided by what is known as the visitor location register (VLR). Each visitor location register is for temporarily serving user devices located within its service area. A visitor location register communicates with the home location register of a user device to fetch any user data that may be required for serving the user device and to provide the home location register with updates regarding the location of the user device.

As with any device provided with hardware and software and linked to a complicated system such as a modern communication system, a user data register and/or an interface linking it to other apparatus may fail. Therefore measures for ensuring resiliency of the user data register may be desired. A way to ensure resiliency of a user data register, for example a home location register, is to provide pairs of mated registers. In such arrangements each register is paired with an extra standby register that may then take over in the event of a failure with the main register. To ensure continuous operation in the case of failure of the main register the data stored in the standby register is typically continuously updated so that it mirrors the data of the main register.

However, use of paired registers may require excessive amount of additional hardware and software. In addition of adding to the overall complexity of the system, set-up and maintenance of mated subscriber data register pairs may be too costly for some applications. Instead, it might be desirable in some cases to be able to reduce the number of any extra registers, such as the standby registers. Furthermore, even the paired registers may not be entirely failsafe as it is possible that even the back-up part of the pair fails.

### SUMMARY

In accordance with an embodiment there is provided an apparatus comprising a data storage configured to store and update a copy of data associated with users of a network and stored in a plurality of respective registers of the network. The apparatus is configured to communicate, subsequent to detection of a failure in association with at least one of the registers, data from the data storage to at least one other register of the plurality of registers.

Another embodiment provides a register apparatus for a communication system comprising a database for maintaining data associated with at least one user allocated thereto. The register apparatus is configured to receive and process data associated with at least one user allocated to another register apparatus and to at least partially provide functions of said other register apparatus subsequent to receiving data associated with said at least one user allocated to the other register apparatus.

Another embodiment provides a communication system comprising a plurality of registers for storing data associated with users, each user being allocated to a register and a data storage apparatus. The data storage apparatus is configured to store and update copies of data stored the plurality of registers. Upon detection of a failure in association with at least one of the registers, the data storage communicates data to at least one other registers of the plurality of registers.

Another embodiment provides a method comprising storing data associated with users of a communication system in a plurality of registers, each user being allocated to a register. In the method copies of data stored in the plurality of registers is stored centrally in a data storage. If a failure is detected in association with at least one of the registers, data associated with a user allocated to the failed register is communicated from the data storage to at least one other register.

In accordance with a more specific embodiment, data associated with said at least one failed register is communicated to a plurality of registers. According to a possibility data is communicated to at least one register replacing said register with the associated failure in response to detection of the failure. Data may also be communicated to said at least one failed register before a recovery of the register and/or subsequent to detection that the register has recovered.

An indication may be included in communications to at least one of the registers that the data relates to a user allocated to another register.

Updates of data associated with a user allocated to a failed register may be received at the storage from at least one replacement register and processed in another register as if the received data were from the failed register.

Updates may be provided with information of the timing thereof. Data for communication to a failed and subsequently recovered register may be based on said information of the timing and the period of failure of the failed register.

A register apparatus may be configured to process differently data that associates with users that are allocated thereto and data that associates with users that are allocated to other register apparatuses. The register apparatus may be configured not to permanently store the data associated with users that are allocated to the other register apparatuses into a database thereof. Alternatively, the register apparatus may be configured to store data associated with a user allocated to another register apparatus.

The register apparatus may be configured to be selectively operational in at least two modes of operation, wherein in a first mode of operation data associated with users that are allocated to other register apparatuses is not stored in the database thereof and in a second mode of operation data associated with users that are allocated to other register apparatuses is stored in a database thereof.

The register apparatus may be configured to update data in the database thereof subsequent to recovery from a failure based on data received from a central database storing copies of data stored in a plurality of register apparatuses.

The method may be provided by means of a computer program embodied on a computer-readable medium.

### BRIEF DESCRIPTIONS OF THE DRAWINGS

For a better understanding of the present invention and how the same may be carried into effect, reference will now be made by way of example only to the accompanying drawings in which:

FIG. 1 shows a schematic presentation of a mobile communication system wherein the invention can be embodied;

FIG. 2 is a flowchart in accordance with an embodiment; and

FIGS. 3 and 4 are flowcharts in accordance with further embodiments.

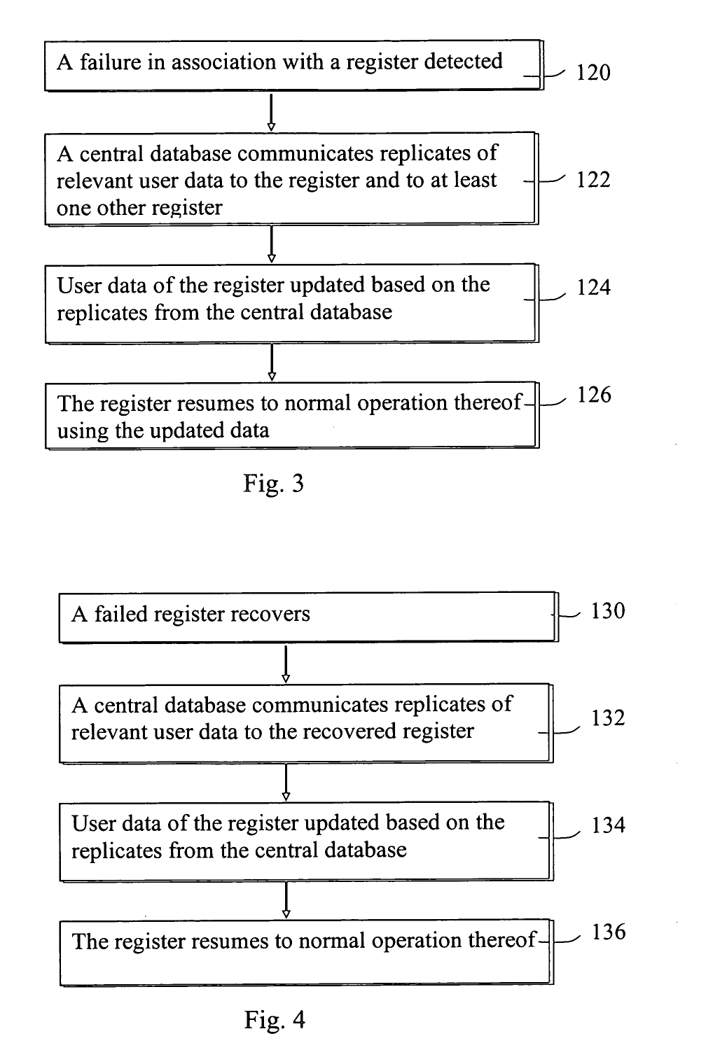

### DESCRIPTION OF EXEMPLYFYING EMBODIMENTS

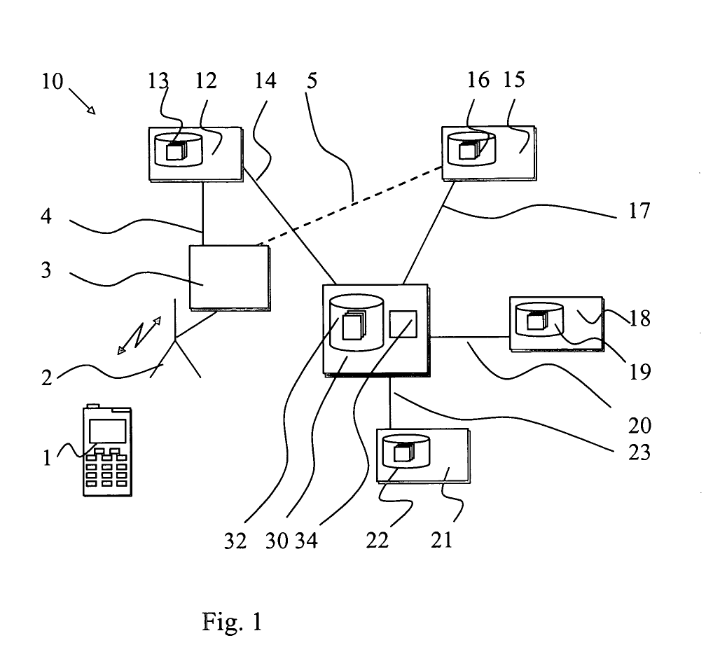

Before explaining in detail certain exemplifying embodiments, certain general principles of wireless communication systems are briefly explained with reference to a system shown in FIG. 1.

A user can use a mobile user device 1 for accessing various services and/or applications provided via a wireless communications system 10. A user of a communication device is often referred to as a subscriber. In mobile communication systems a wireless interface is provided between the mobile user device 1 and an appropriate wireless access system 2. For example, the mobile user 1 can access wirelessly a communication system via at least one base station or similar wireless transmitter and/or receiver node. Non-limiting examples of appropriate access nodes are a base station of a cellular system and a base station of a wireless local area network (WLAN). Each mobile device may have one or more radio channels open at the same time and may be connected to more than one base station.

The mobile user device 1 can be used for various tasks such as making and receiving phone calls, for receiving and sending data from and to a data network and for experiencing, for example, multimedia or other content. An appropriate user device may be provided by any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The mobile user device 1 may communicate via an appropriate radio interface. A mobile user device is typically provided with at least one data processor and at least one memory.

The base station system is typically controlled by at least one appropriate controller entity. Non-limiting examples of these include a base station controller and a radio access network controller. A base station system 2 is connected to control nodes of the cellular network for enabling communications over a wider area. For example, the base station may be connected to a mobile switching centre (MSC), a MSC server (MSS) or similar network controller 3 providing overall control of communications between access systems and other nodes. The network controller entity is typically provided with a memory and at least one data processor.

A mobile communication is also typically provided with a plurality of registers for storing data that is associated with individual users. This data may include user data such as subscriber profiles, location data and so forth. Each of the users is typically allocated to a user data register. These registers can be each provide, for example, a home location register (HLR) of a cellular system.

FIG. 1 thus also shows a plurality of user data registers 12, 15, 18 and 21. Each of the registers is configured to store relevant user data in its database 13, 16, 19 and 22, respectively. In the example of FIG. 1 user data associated with the user device 1 is stored and maintained by register 12 connected to the controller 3 via connection 4. In other words, user 1 belongs to register 12, and in normal operation the other registers 15, 18 and 21 have no association with the user device 1.

FIG. 1 shows further a centralised data storage or repository entity 30. The data storage entity is connected via respective interfaces 14, 17, 20 and 23 to the plurality of registers for communication of user data as will be explained in more detail below. The data storage entity is provides with data storage or database 32 for maintaining user data and a processor 34 for overall control of the operation thereof.

The controller 3 may in certain applications be provided with a direct connection with the centralised data storage 30. However, this is not required in carrying out the herein described embodiments, and is therefore not shown for clarity.

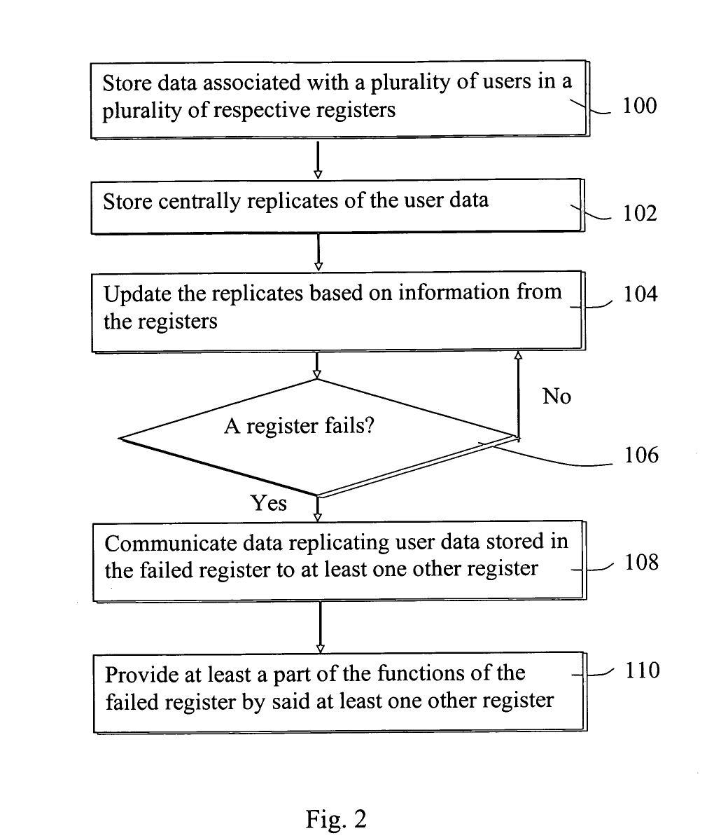

A reference is now also made to the flowchart of FIG. 2 illustrating operation in accordance with an embodiment where the centralized data storage entity 30 is used as follows. Each of the distributed registers 12, 15, 18 and 21 stores and maintain user data regarding its respective allocated users in it is database at 100. Each of the registers sends at 102 information of any updates in its own local database 13, 16, 19 and 22 substantially in real-time to the centralized data storage 30. The centralized data storage 30 can then create and/or update at 104 records in its database 32 and to provide a backend storage for user data of the plurality of distributed registers. In other words, the same data is now stored in the HLR and the centralized repository. The central data storage 30 thus provides a real-time backup system for the distributed registers.

One of the allocated user data registers, such as the register 12, may fail at 106. Upon detection of the failure the traffic of the failed register may be shared between one or more of the other similar registers in the network that are still operational. This is indicated by the dashed line 5 between the controller 3 and the register 15 indicative of the situation where the controller 3 communicates with the register 15 instead of register 12.

To be able to serve the user device 1 the other registers may fetch relevant subscriber data at 108 from the centralized repository 30. In 108 data may be sent to any of the HLRs based on requests, and therefore it is not necessary to transfer the entire database of the failed HLR. The fetching may be triggered e.g. by detection that relevant user data is not found from the database 16 of the replacement register 15 whereto at least a part of the traffic of the user 1 has been directed to instead of the failed register 12. After the replacement register has the necessary data, it may provide at least a part of the functions of the failed register at 110.

The centralized data storage apparatus 30 or repository can be configured to clearly indicate in its communications if a user belongs to another register. Based on this indication a replacement register handling the transaction instead of the “correct” register (i.e. a register that is allocated for the user) may make a decision not to store the fetched user data to its own local database. This can be used advantageously for avoiding a need for additional memory capacity in the local register. Instead, only signalling capacity between the central and the replacement register(s) is used when sharing the tasks of a failed register. Another advantage of not storing subscriber data to a database of a replacement register is that duplicate subscribers can be avoided when the failed register restarts to serve its own subscribers. Thus there is no need to delete subscribers from the registers to get a consistent state.

Detection of a failure may be provided in various manners and in various nodes. In accordance with an embodiment a network controller, for example a MSC server (MSS) may be configured to detect if a certain signalling point such as a home location register (HLR) or another user data register or any associated link is out of service.

A possibility is to employ a Global Title (GT) analysis in redirecting transaction to other registers. The GT analysis is used in controllers such as MSS or MSC to define which HLR has data of a certain subscriber. The analysis uses subscriber identity such as international mobile subscriber identity (IMSI) or mobile station international integrated services digital number (MSISDN) to define a correct HLR. For example, an analysis can define as the primary result that IMSIs 1000-2000 are handled by HLR1, the address of which is 7777, IMSIs 2001-5000 are handled by HLR2, the address of which is 8888 and so on. A secondary alternative may be configured into the analysis result so that the controller starts to send the register transactions to one or more replacement registers that are still functional in the network. The sending may be based on an appropriate address pool of the registers. This can be used when the HLR given in the primary analysis result does not respond, for example due to connection break or a HLR failure. The secondary analysis may result load sharing such that e.g. if HLR1 does not respond, the traffic destined to it is handled by the remaining HLRs, for example by HLR2, HLR 3 and HLR4. The controller may spread transactions which are normally handled by HLR1 evenly for HLRs 2 to 4. The spreading may be based on any appropriate principle, for example first transaction to HLR2, second to HLR3 and so on. Secondary analysis result can also be a single address instead of a load sharing pool.

In certain mobile networks information associated with a mobile user may be stored in two places, namely in a visitor location register (VLR) and a home location register (HLR). From these the latter is for permanently storing user data associated with given users whereas the former is for serving users within a particular service area. A visitor location register sends updated location information to a home location register allocated to a particular user. The visitor location register may also fetch any user information that may be needed for enabling communications for the user. If the communication system is provided with home and visitor location registers or similar, the dialog between the HLR and VLR entities may be handled so that one dialog or transaction is always done between same visitor and home location register pair. The HLR is then responsible for delivering replicate modifications to the centralized data storage after the transaction has completed. The temporary data during the transaction is stored only in the HLR. In this context the term ‘dialog’ is intended to mean a communications where a pair of registers exchange multiple messages concerning a single network transaction. An appropriate communication mechanism may be used for the transactions. For example, a connectionless Transaction Capabilities Application Part (TCAP) mechanism may be used for communication between the entities. An advantage of the TCAP is that it is capable of handling the entire messaging of a transaction in one dialog.

An address of a home location register can be stored in a visitor location register that is serving the mobile user when performing a location update. Requests and updates targeted to a failed home location register may then be routed to one replacement register by using single address as secondary result or to several replacement registers by using a load sharing pool as secondary result, for example based on the GT analysis described above. According to a possibility the address of the failed register is temporarily assigned to the replacement register.

If the register is provided with its own local database and a transaction comes to the register with a subscriber identity it does not recognize, then the register may try to fetch the information from the centralized repository on fly. The centralized repository 3 may then inform the replacement register that this subscriber belongs already to some other register and thus there is no need to permanently store the information.

According to a further embodiment there is provided a mechanism that allows automatic traffic routings between the controller 3 and the distributed registers 12, 15, 18 and 21. This may be performed so that data in a replacement register is based only on a real-time backup stored in a central database. If a register fails in a network, the controller 3 may then route the traffic to the replacement register automatically. The decision may be taken at the controller e.g. based on the above mentioned secondary GT analysis result. According to a possibility, if Signalling Transfer Points (STP) are employed in the network, these may route traffic to the replacement register. The replacement register can then fetch the profile data from centralized real-time backup. The central database apparatus 30 maintaining the real-time backup may notice at this stage that the traffic is coming from a replacement register rather than the register the subscriber in reality belongs to, and add an indication of this into its records. The central database then updates the replicate data according to the reports from the replacement register as if they were from the original register.

A possibility is that a flag is added to messages associated with users belonging to a failed register subsequent to sharing the load of the failed register. When another register receives such message, instead of looking from its own database, the register can fetch the corresponding data from the centralized repository. In other words, the registers work in a ‘dataless’ mode when serving users who are flagged to be handled based on data from centralized database. The flagging may be done, for example, by the controller 3 or the centralized repository 30 of FIG. 1.

Further embodiments address the issue of correctness of user data in a recovered register. As explained above, distributed subscriber data registers may send information regarding updates coming from the network in real time to a centralized subscriber database. If one of the distributed registers fails, the traffic of the failed register can be routed automatically to a replacement register. It is, however, possible that the failed register then recovers and returns back to an operational state. Thus, the traffic can be turned back to the original, failed register after a while. The return to normal state may be triggered automatically in response to detection of the recovery.

In certain situations, however, the profile of the subscriber may have changed in the meanwhile in the replacement register. The updated data may be lost when the failed register becomes active again. Thus, if the failed register becomes alive again and the controller 3 returns traffic automatically back to it, the subscription related profile information stored therein might be old.

According to a possibility the failed register is kept up to date by keeping the data up to date in all associated registers, including the failed register, in the case of a failure. To provide this the central database does not overwrite the original register address information of the subscriber in its records. Instead, the central database also keeps the failed register “in the loop” and informs it of any updates coming from the replacement register(s) at 122. This may be useful, for example, in situations where there is a link failure between the controller 3 and the original register 12 at 120, rather than any failure in the register itself. The updates may go trough, despite the failure, and the original register is kept up to date all the time, and may be taken immediately back to use once the link failure is removed at 126.

Instead of updating a failed register on real-time, a possibility is to employ time-stamps in the centralized data storage. When a data change from a replacement register is updated to the centralized data storage, it sets a time stamp to updated subscriber record in its own database. The failed register is not updated at this stage. When the failed register becomes available again, only such data of subscribers that has changed is uploaded to the failed register. The changed data can be determined by comparing the time-stamps to the start time of the failure. The partial restore mechanism may be advantageous when compared to full upload of data to a failed register especially in cases where the failure lasts a relatively short period.

If a failed register can still be seen by the central data storage entity 30, it may command the failed register to remove data associated with such a subscriber that the central entity noted as being referred to in a transaction coming from a replacement register. If the failed register becomes again visible to the other elements of the network, then transactions coming to the deleted subscribers can be handled so that the register fetches the corresponding data from the centralized repository in real-time and stores the data to its local database.

According to a possibility shown in FIG. 4 the central data storage entity communicates replicates of the relevant user data to the recovered register at 132 as soon as it has been detected that the register has returned to the operational state at 130. The register then updates its records at 134 and resumes to normal operation at 136.

A possibility is that the replacement register queries only for the location of the failed register from the centralized repository and tries first to reroute messages to the failed register. When data inquiry from the network controller associated with a certain subscriber comes to the replacement register, the replacement register can get from the centralized repository the address of the failed register based on subscriber identity in the inquiry. The replacement register can then reroute the inquiry to the failed register. This may be particularly advantageous if the failed register is unreachable for the network controller. For example, the connection between a MSS and one register element (HLRX) may be lost, but connection from the MSS to the replacement register and from the replacement register to the HLRx may still exist. The rerouting may be based on any appropriate mechanism, for example by the mobile application part (MAP).

If a register has totally failed, for example due to a mechanical failure, it may need to be taken out of the network and fixed. In such occasion an operator of the network may command the replacement register to a mode where it stores the replicate data in its own database, i.e. to a ‘datafull’ mode. In this mode the new register may start to cache subscription information also to its own local database. After a while the new register can take fully the role of the failed register.

If the failed register can be fixed and is put back into the network again, the controller 3 may then start to automatically send relevant transactions to it. The database of the repaired register may, however, be empty and in any case out of date. Therefore the repaired register fetches first relevant replicates of the subscription data from the centralized real-time backup database containing information updated by the replacement register.

A replacement register can be selectively operated in both a dataless and dataful mode, and can be switched between these modes. The decision regarding the appropriate mode may depend on various factors, for example the type of failure, overall operating conditions in the network and capacity of the replacement register.

The embodiments may also be advantageously used even if only a part of the functions of a register fail. The traffic of the partially failed register that it cannot handle may be shared among a plurality of functioning registers in the network.

If even a replacement register fails, this failure can be treated in the similar manner and the traffic thereof can be shared between the remaining register.

The embodiments may also be employed to provide a rolling upgrade mechanism where active registers are taken out of service, one-by-one. The functions of the one register are provided by other registers during the period it is not in service. After the upgrade thereof is finished the register can be put back in service, and it may assume its old responsibilities based on up to date data from the centralised database.

The above examples may allow efficient utilization of dynamic capacity should at least one of the plurality of registers go out of service. Network planning and management may be made easier. Data may be stored, updated and used in a consistent manner even in the cases of cases of failure where a network controller can automatically route the traffic between failed and replacement registers.

The required data processing functions may be provided by means of one or more data processors of a central database entity and distributed registers. An appropriately adapted computer program code product or products may be used for implementing the embodiments, when loaded on an appropriate processor. The program code means may, for example, perform detection of a failure, control updating and sending of information, selection of appropriate replacement register(s) generation of messages and/or information elements, interpretation of information and so forth. The program code product for providing the operation may be stored on and provided by means of a carrier medium such as a carrier disc, card or tape. A possibility is to download the program code product to the mobile device via a data network.

It is noted that whilst embodiments have been described in relation to mobile user devices such as mobile terminals, embodiments of the present invention are applicable to managing user data associated with users of any other suitable type of communication apparatus.

It is also noted that although certain embodiments were described above by way of example with reference to the exemplifying architectures of certain cellular networks, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention as defined in the appended claims.

We claim:

1. An apparatus comprising a data storage configured to store and update a copy of data associated with users of a network and stored in a plurality of respective registers of the network, wherein the apparatus is configured to communicate, subsequent to detection of a failure in association with at least one of the registers, data from the data storage to at least one other register of the plurality of registers.

2. An apparatus as claimed in claim 1, wherein the apparatus is configured to communicate data associated with said at least one failed register to a plurality of registers.

3. An apparatus as claimed in claim 1, wherein the apparatus is configured to communicate data to at least one register replacing said register with the associated failure in response to detection of the failure.

4. An apparatus as claimed in claim 3, wherein the apparatus is configured to communicate data also to said at least one failed register before a recovery of the register.

5. An apparatus as claimed in claim 3, wherein the apparatus is configured to communicate data also to said at least one failed register subsequent to detection that the register has recovered.

6. An apparatus as claimed in claim 1, wherein the apparatus is configured to include an indication in communications to at least one of the registers that the data relates to a user allocated to another register.

7. An apparatus as claimed in claim 1, configured to receive a message reporting a failure in association with one of the registers

8. An apparatus as claimed in claim 1, wherein the apparatus is configured to direct communications to the registers based on a global title (GT) analysis.

9. An apparatus as claimed in claim 1, configured to receive updates of data associated with a user allocated to the failed register from at least one replacement register and to process the received data as if it were from the failed register.

10. An apparatus as claimed in claim 1, configured to command the failed register to remove data associated with a user handled by another register.

11. An apparatus as claimed in claim 1, configured to provide updates with information of the timing thereof and to select data for communication to a failed and subsequently recovered register based on said information of the timing and the period of failure of the failed register.

12. An apparatus as claimed in claim 1, configured for communication of data associated with users with home location registers of a mobile communication network.

13. An apparatus as claimed in claim 1, comprising a subscriber location information back-up database for a mobile communication network.

14. A register apparatus for a communication system comprising a database for maintaining data associated with at least one user allocated thereto, the register apparatus being configured to receive and process data associated with at least one user allocated to another register apparatus and to at least partially provide functions of said other register apparatus subsequent to receiving data associated with said at least one user allocated to the other register apparatus.

15. A register apparatus as claimed in claim 14, being configured to request for relevant data associated with the at least one other user from a central database storing copies of data stored in a plurality of register apparatuses.

16. A register apparatus as claimed in claim 14, being configured to request for data from a central database in response to detection that relevant data associated with a user is not stored in a database thereof.

17. A register apparatus as claimed in claim 14, being configured to detect an indication in a communication from a central database that the data in the communication relates to a user allocated to another register apparatus.

18. A register apparatus as claimed in claim 14, being configured to provide location register functions to users that are allocated thereto and also to users that are allocated to other location registers.

19. A register apparatus as claimed in claim 14, being configured to process differently data that associates with users that are allocated thereto and data that associates with users that are allocated to other register apparatuses.

20. A register apparatus as claimed in claim 19, wherein the register apparatus is configured not to permanently store the data associated with users that are allocated to the other register apparatuses into a database thereof.

21. A register apparatus as claimed in claim 14, wherein the register apparatus is configured to store data associated with a user allocated to another register apparatus.

22. A register apparatus as claimed in claim 14, wherein the register apparatus is configured to be selectively operational in at least two modes of operation, wherein in a first mode of operation data associated with users that are allocated to other register apparatuses is not stored in the database thereof and in a second mode of operation data associated with users that are allocated to other register apparatuses is stored in a database thereof.

23. A register apparatus as claimed in claim 14, wherein the register apparatus is configured to update data in the database thereof subsequent to recovery from a failure based on data received from a central database storing copies of data stored in a plurality of register apparatuses.

24. A communication system comprising:
a plurality of registers for storing data associated with users, each user being allocated to a register; and
a data storage apparatus configured to store and update copies of data stored in the plurality of registers, wherein the data storage apparatus is configured to communicate, subsequent to detection of a failure in association with at least one register, data to at least one other register of the plurality of registers.

25. A communication system as claimed claim 24, comprising a controller connected with the plurality of register and the data storage apparatus, wherein the controller is configured to inform the data storage apparatus of a failure in association with one of the registers.

26. A communication system as claimed in claim 24, comprising a controller connected with the plurality of register and the data storage apparatus, wherein the controller is configured to detect a failure in association with one of the registers and to direct communications associated with the failed register to at least one other register.

27. A communication system as claimed in claim 24, wherein the registers comprise home location registers.

28. A communication system as claimed in claim 27, further comprising at least one visitor location register, wherein the visitor location register is arranged to communicate with at least one other home location register instead of a failed home location register that is allocated to a user.

29. A method comprising:
storing data associated with users of a communication system in a plurality of registers, each user being allocated to a register;
receiving and storing centrally copies of data stored in the plurality of registers;
detecting a failure in association with at least one of the registers; and
subsequent to the detection, communicating data associated with a user allocated to the failed register from the data storage to at least one other register.

30. A method as claimed in claim 29, wherein the communicating comprises communicating of data to a plurality of registers.

31. A method as claimed in claim 29, wherein the communicating comprises communicating of data to said at least one failed register and at least one other register replacing said register with associated failure.

32. A method as claimed in claim 29, comprising performing at least a part of the functions of the failed register by at least one other register based on the centrally stored data.

33. A method as claimed in claim 29, comprising including an indication in communications to at least one of the registers that the data relates to a user allocated to another register.

34. A method as claimed in claim 29, comprising detecting that the user is allocated to another register and sending a request for relevant data associated with the user to a central database storing the replicates of data.

35. A computer program embodied on a computer-readable medium, the computer program configured to provide a method comprising:
receiving and storing centrally copies data stored in a plurality of registers for storing data associated with allocated users of the network;
detecting existence of a failure in association with at least one of the registers; and
subsequent to the detection, communicating data associated with a user allocated to the failed register from the data storage to at least one other register.

36. A computer program as claimed in claim 35, being configured to control communication of data associated with a user of the failed register to a plurality of registers.
